(19) United States
(12) Patent Application Publication
(10) Pub. No.: US 2009/0021475 A1
(43) Pub. Date: Jan. 22, 2009

(54) METHOD FOR DISPLAYING AND/OR PROCESSING IMAGE DATA OF MEDICAL ORIGIN USING GESTURE RECOGNITION

(76) Inventors: Wolfgang Steinle, Munich (DE); Nils Frielinghaus, Heimstetten (DE); Christoffer Hamilton, Munich (DE); Michael Gschwandtner, Munich (DE)

Correspondence Address: DON W. BULSON (BRAI), RENNER, OTTO, BOISSELLE & SKLAR, LLP, 1621 EUCLID AVENUE - 19TH FLOOR, CLEVELAND, OH, 44115, US

(21) Appl. No.: 12/176,027

(22) Filed: Jul. 18, 2008

Related U.S. Application Data
(60) Provisional application No. 60/957,311, filed on Aug. 22, 2007.

(30) Foreign Application Priority Data
Jul. 20, 2007 (EP) 07 014 276

(51) Int. Cl. G09G 5/00

(52) U.S. Cl. 345/156

(57) ABSTRACT

A method for processing and/or displaying medical image data sets in or on a display device having a screen with a surface, including: detecting gestures performed on or in front of the screen surface; correlating the gestures to predetermined instructional inputs; and manipulating, generating, or retrieving, via computer support, the medical image data sets in response to the instructional inputs.

### RELATED APPLICATION DATA

This application claims priority of U.S. Provisional Application No. 60/957,311 filed on Aug. 22, 2007, and EP 07 014 276 filed on Jul. 20, 2007, which are incorporated herein by reference in their entirety.

### FIELD OF THE INVENTION

The invention relates generally to display of medical images and, more particularly, to a method for displaying and/or processing medical image data.

### BACKGROUND OF THE INVENTION

Medical image data may be produced two-dimensionally or three-dimensionally using several medical imaging methods (for example, computer tomography, magnetic resonance tomography, or x-ray). The resulting image data is increasingly stored as digital image data or digital image data sets. Some systems used for storing this image data bear the English designation Picture Archiving and Communication Systems (“PACS”). Primary viewing and/or evaluation of such digital image data often is limited to radiologists working in dedicated viewing rooms that include high-resolution, high-luminance monitors.

Outside of radiology, the transition from traditional film image viewing to digital image viewing is proceeding more slowly. Images that are viewed digitally in radiology may be reproduced onto film for secondary use access by other departments within a hospital, for example. This resulting dichotomy may be attributed to two reasons: (1) the fact that PACS computer programs are highly adapted to radiologists and (2) the PACS computer programs are often difficult to operate. Additionally, many physicians are accustomed to working with a film viewer that is illuminated from behind, also known as a “light box.”

Efforts to make digital image data more accessible for secondary use outside of radiology include using large-screen monitors in operating theaters, wherein, for example, the monitors can be operated using wireless keyboards or mice. Also used are simple touch screen devices as well as separate dedicated cameras for recognizing control inputs from physicians or operating staff.

US 2002/0039084 A1 discloses a display system for medical images that is constructed as a film viewer or light box. The reference also discloses various ways of manipulating medical images (for example, inputs via a separate control panel, remote controls, touch screen applications, and voice control).

### SUMMARY OF THE INVENTION

In a method in accordance with the invention, a display device comprising at least one screen may be used as follows:
image data sets may be processed by a computer data processing unit (integrated in the display apparatus) to generate image outputs and/or to change and/or confirm the image data;
image data sets may be manipulated, generated, or retrieved via instructional inputs at the screen itself; and
the instructional inputs may be identified using the data processing unit and gesture recognition, wherein the gestures can be generated manually or through the use of a gesture generating apparatus.

In other words, the method in accordance with the invention entails using a digital light box that includes an optimized command input system based on processing gestures performed by a user. The method can be performed directly on or at the screen or can be detected by a detection system that is directly assigned to the screen. The gestures that are processed may be inputs that are assigned a specific meaning in accordance with their nature, or inputs that can be assigned a specific meaning by the display apparatus or its components.

Gesture recognition (together with input recognition devices associated with the screen) can enable the user to perceive medical image data through quick and intuitive image viewing. Its use can make image viewing systems better suitable for operating theaters because sterility can be maintained. Image viewing systems that use the method in accordance with the invention can be wall-mounted in the manner of film viewers or light boxes and provide the user with a familiar working environment. Devices such as mice and keyboards or input keypads that are difficult to sterilize may be eliminated. Additionally, gesture recognition may provide more versatile viewing and image manipulation than provided by conventional systems.

### BRIEF DESCRIPTION OF THE DRAWINGS

The forgoing and other features of the invention are hereinafter discussed with reference to the figures.

FIG. 1 shows a schematic depiction of an exemplary digital light box in accordance with the invention.

FIG. 2 shows an exemplary representation of a planar input.

FIGS. 3a to 3d show examples of image viewing in accordance with the invention.

FIGS. 4a to 4c show an example of enlarging a screen section in accordance with the invention.

FIGS. 5a to 5d show an example of generating a polygon in accordance with the invention.

FIGS. 6a to 6d show examples of mirroring and/or tilting an image in accordance with the invention.

FIGS. 7a and 7b show examples of retrieving a hidden menu in accordance with the invention.

FIGS. 8a to 8c show examples of operating a screen keyboard in accordance with the invention.

FIGS. 9a to 9d show examples of scrolling in accordance with the invention.

FIGS. 10a to 10c show an example of selecting a point in a diagram in accordance with the invention.

FIGS. 11a to 11f show examples of manipulating a diagram in accordance with the invention.

FIG. 12 shows an example of recognizing a left-handed or right-handed person in accordance with the invention.

FIGS. 13a to 13c show examples of generating and/or manipulating a line in accordance with the invention.

FIGS. 14a to 14h show examples of manipulating image representations of patient data sets in accordance with the invention.

FIGS. 15a to 15d show examples of assigning points in accordance with the invention.

FIG. 16 shows an example of confirming a command in accordance with the invention.

FIG. 17 shows an example of gaging an object in accordance with the invention.

FIGS. 18a and 18b show examples of generating a circular contour in accordance with the invention.

FIG. 19 shows an example of manipulating an implant in accordance with the invention.

FIGS. 20a to 20c show an example of interpreting an input, depending on the image contents in accordance with the invention.

FIG. 21 shows an example of setting a countdown in accordance with the invention.

FIG. 22 shows an example of inputting a signature in accordance with the invention.

FIGS. 23a to 23c show examples of manipulating a number of image elements in accordance with the invention.

FIG. 24 shows a block diagram of an exemplary computer that may be used with any of the methods and/or display systems described herein.

### DETAILED DESCRIPTION

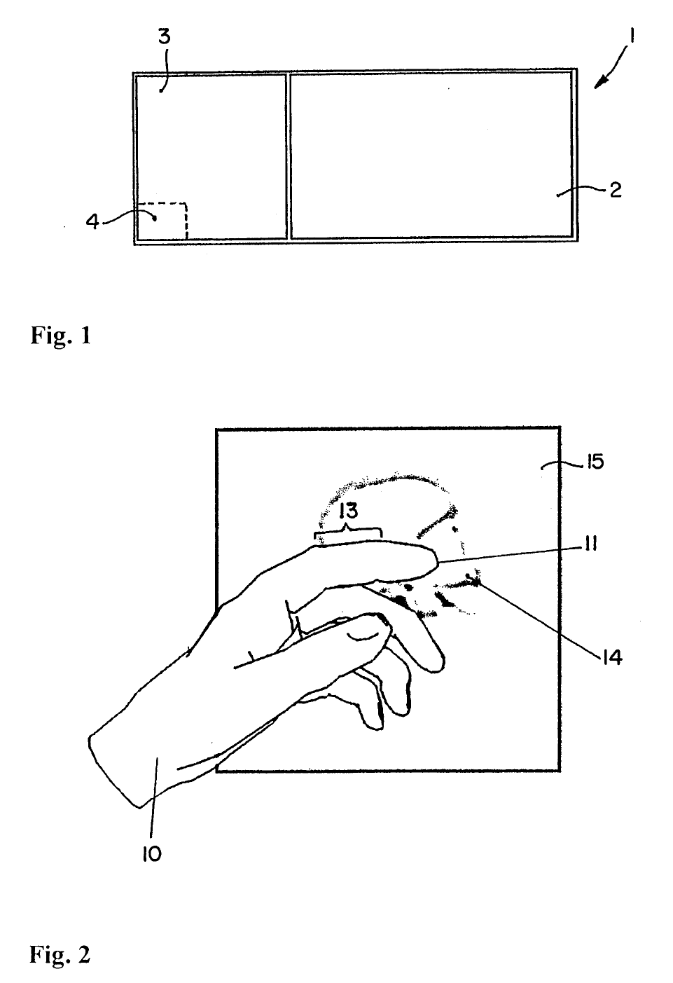

FIG. 1 shows a schematic representation of an exemplary digital light box that can be used to implement a method in accordance with the invention. The digital light box (display apparatus) 1 can include two separate screens or screen parts 2, 3 and an integrated computer data processing unit 4 (schematically shown). In accordance with the invention, it is possible to load image data sets into the light box 1 using the computer data processing unit 4. The data processing unit 4 also can control the representation of the image data sets in accordance with input gestures. Optionally, the data processing unit 4 also can determine changes or additions to the data sets made via the input gestures, and can correspondingly alter the data sets. In an example in accordance with the invention, the screens or screen parts 2, 3 may be so-called multi-touch screens. Using this technology, it is possible to detect a number of inputs simultaneously (for example, inputs at different positions on the screen or planar inputs). The screens can detect inputs from contact with the screen surface or from a presence in the vicinity of the surface of the screen (for example, via the use of an infrared beam grid).

Integrating the data processing unit 4 into the digital light box 1 can create a closed unit that can be secured to a wall. Optionally, the data processing unit 4 may be provided as a standalone computer having its own data input devices and may be operatively connected to the digital light box 1. The two screen parts 2, 3 may be arranged next to each other, wherein the smaller screen 3 provides a control interface (for example, for transferring data, assigning input commands, or selecting images or image data) and the images themselves may be shown on the larger screen 2. In the example shown, the width of the smaller screen 3 may correspond to the height of the larger screen 2, and the smaller screen 3 may be rotated by 90 degrees.

FIG. 2 illustrates how planar input gestures can be generated within the framework of the present invention. FIG. 2 shows a screen section 15 on which an image 14 is displayed (in this example, a schematic depiction of a patient's head). An operator's hand 10 is shown, wherein a region of the second phalanx of the left-hand index finger is shown as a planar region 13. Also shown is a tip of the index finger as a point 11. Within the framework of the invention, an operator can make a point contact with the screen surface with fingertip 11. Additionally, the operator may make a planar contact between the screen and the region 13 of the index finger (or also the entire finger).

Whenever the term “contact” is used herein for an input at the screen, this term includes at least the two types of input at the screen that have already been mentioned above, namely contact with the screen, and near-contact with the screen (for example, from a presence directly at or in a (nominal) distance from the surface of the screen). As shown in FIG. 2, the operator can perform different input gestures that can include punctual contact and planar contact. These different inputs can be interpreted differently to equip the operator with another dimension for inputting data or instructions. Some examples of different input interpretations that can be assigned to a planar contact or a punctual contact and can be differentiated by the types of contact include:
a) shifting images on the screen;
b) selecting a position in a scroll bar;
c) moving a scroll bar cursor to a chosen position for quicker selection in a scroll field;
d) playing or pausing animated image sequences; or
e) selecting options in a field comprising a number of (scrollable) options (for example, changing the type of sorting).
   More detailed references are made herein to these and other contact examples.

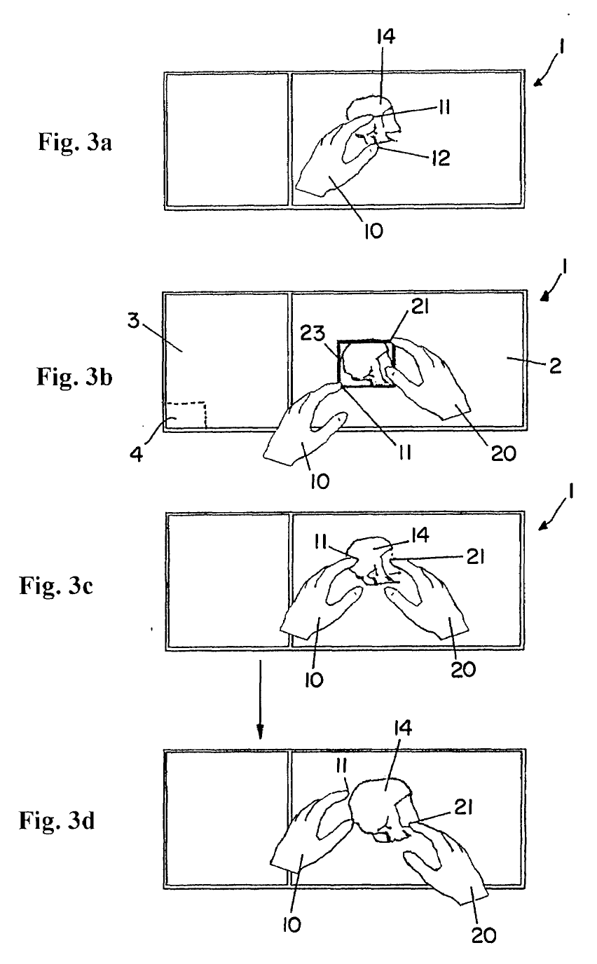

FIGS. 3a to 3d show possible uses of the method in accordance with the invention when viewing images. FIG. 3a shows how a selected image 14 can be influenced by a contact using one or two fingertips 11, 12 of one hand. An example of such influence could be that of modifying the brightness and contrast using a combination of gestures performed using the fingertip or fingertips 11, 12. For example, the brightness can be adjusted by touching the screen with a single fingertip and then performing a horizontal movement, while a vertical movement adjusts the contrast. Another exemplary gesture could be moving the fingertips 11, 12 apart or together. Software is provided and executed by data processing unit 4 (shown in FIG. 3b) to correspondingly respond to such gestures.

FIG. 3b shows how a certain screen section (shown by a rectangular outline 23) can be selected with the aid of two fingertips 11, 21 of two hands 10, 20. Using suitable inputs, the selected screen or image section can be further processed in accordance with the wishes of the viewer. For example, the outline 23 can be selected by touching an image 14 with two fingertips 11, 21 simultaneously. FIGS. 3c and 3d show enlargement of the image 14 via a gesture of simultaneously touching an image with the fingertips 11, 21 and then drawing said fingertips apart. Corresponding command assignments may be stored in a memory of data processing unit 4 and can be assigned in the gesture recognition software of the data processing unit 4. It may be possible to change these assignments in the software: for example, the user may select a particular interpretation beforehand using the left-hand, small screen 3 of the light box 1, and the entered gesture can be assigned to a selected command. This, or similar methods for changing assignments in the software can apply equally to all of the examples described herein.

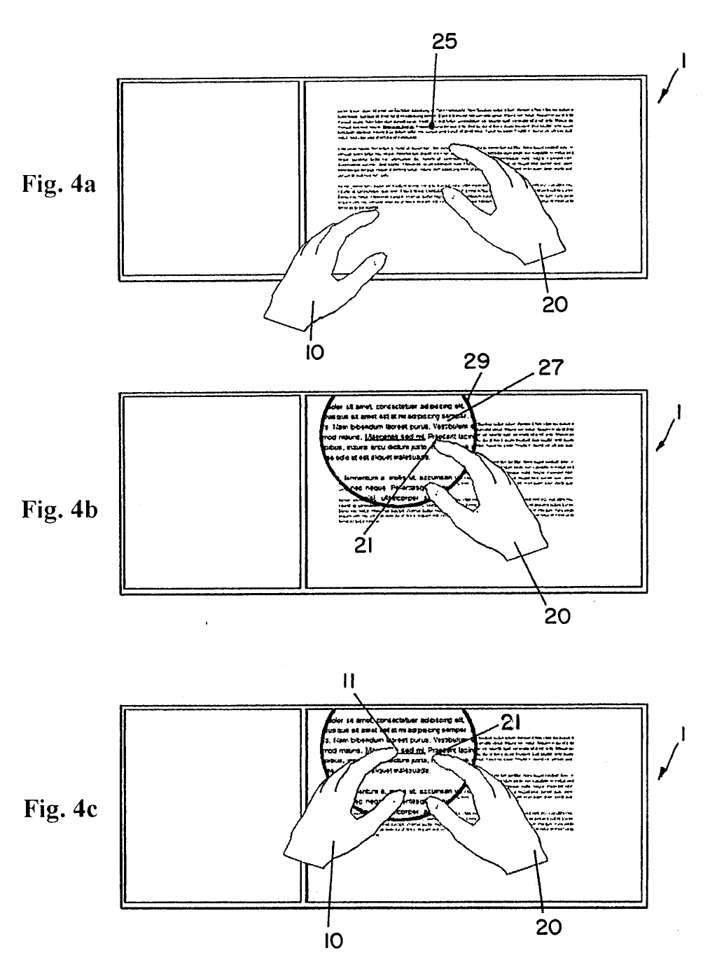

In accordance with the invention, an enlarging command is illustrated in FIGS. 4a to 4c. For example, if a text 25 is shown on the screen, gesture recognition can include an assignment in which a first screen contact using the fingertip 21 enlarges a region in the vicinity of the point of contact. The region is shown in the manner of a screen magnifier having a rim 29. The enlarged text 27 is shown in this region, and it may be possible (turning to FIG. 4c) to then select text (for example, a hyperlink) via a second contact 11 parallel or subsequent to the first contact. It may be desired to require that the second contact stay within the enlarged region. Alternatively, it is possible for the second contact to trigger a different process (for example, marking an area of the image) that need not be a text element but can be a particular part of an anatomical representation.

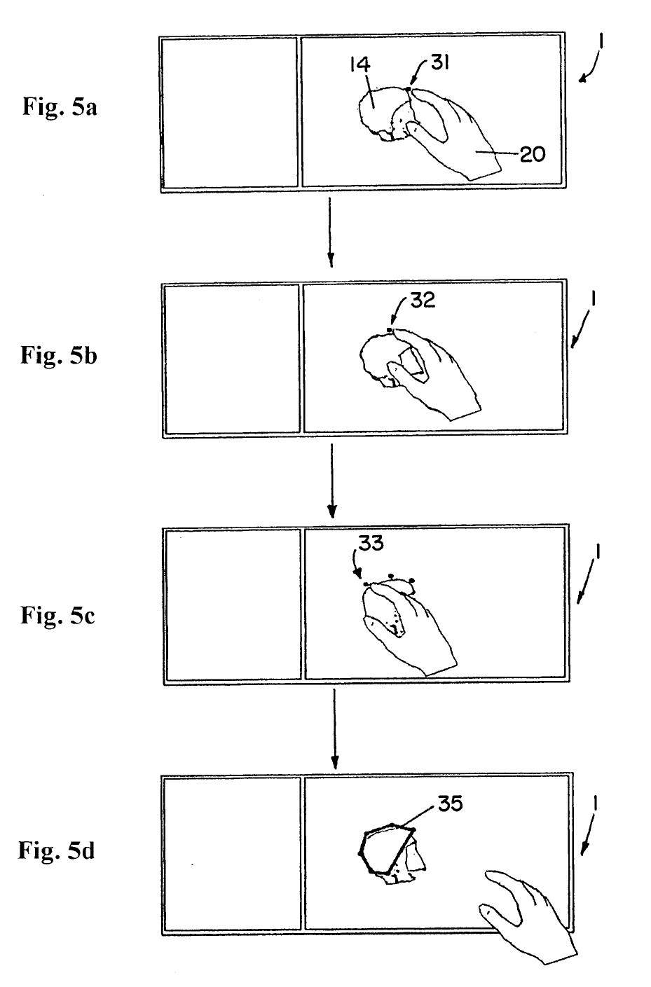

One exemplary variation of the method in accordance with the invention, in which a polygon may be generated, can be seen in FIGS. 5a to 5d. In this variation, a series of contacts may trigger the selection and/or definition of a region of interest (for example, a bone structure in a medical image 14). A first contact 31 may be interpreted as a starting point for the region of interest and/or the polygon, and as long as the first point 31 remains active (to which end a fingertip can, but need not necessarily, remain on the first point), subsequent contacts 32, 33 may be interpreted as other points on a boundary line of the region of interest. By returning to the first point 31 via other points 32, 33, etc., it is possible to indicate that a region of interest or polygon 35 has been completely defined. This region definition also can be achieved via a different series of contacts or by removing all the contacts.

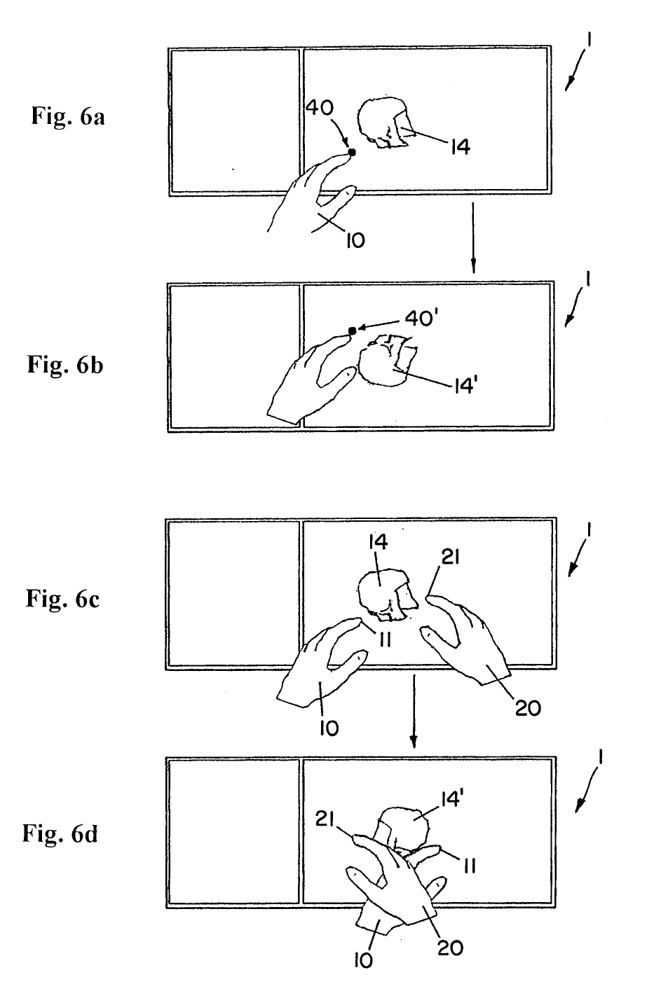

Another exemplary image manipulation is shown in FIGS. 6a to 6d, namely that of mirroring and/or tilting an image 14 on the light box 1. FIGS. 6a and 6b show how an image 14 can be tilted and/or mirrored about a horizontal axis (not shown) by shifting a virtual point or button 40 from the bottom up to a new point 40′ using a fingertip 11. If the shift is in the horizontal direction, the corresponding tilt may be about a vertical axis. After the tilting process has been performed, the button remains at the shifted position 40′ to indicate that the image has been tilted and/or mirrored.

FIGS. 6c and 6d show an exemplary two-handed tilting and/or mirroring gesture. If the two fingertips 11, 21 of the hands 10, 20 are slid towards and past each other while touching the image, this may be interpreted as a command to tilt and/or mirror the image 14 about a vertical axis. It is also possible, by correspondingly moving the fingers in opposite vertical directions, to mirror the image about a horizontal axis.

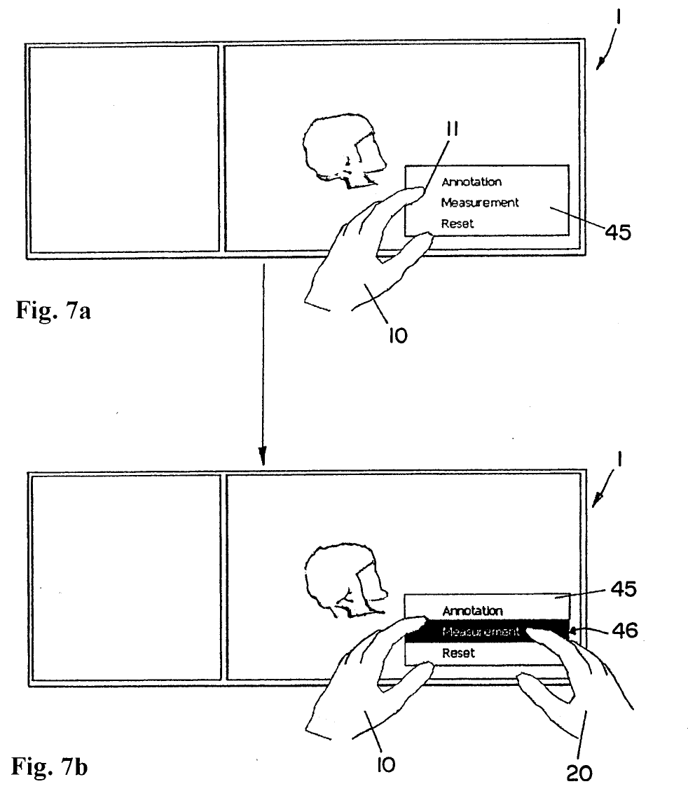

The exemplary input shown in FIGS. 7a and 7b relates to retrieving an otherwise hidden menu field 45 using a first finger tip contact 11 (FIG. 7a). In this manner, it is possible to make a selection in the expanded menu (in this example, the middle command field 46) using a second contact.

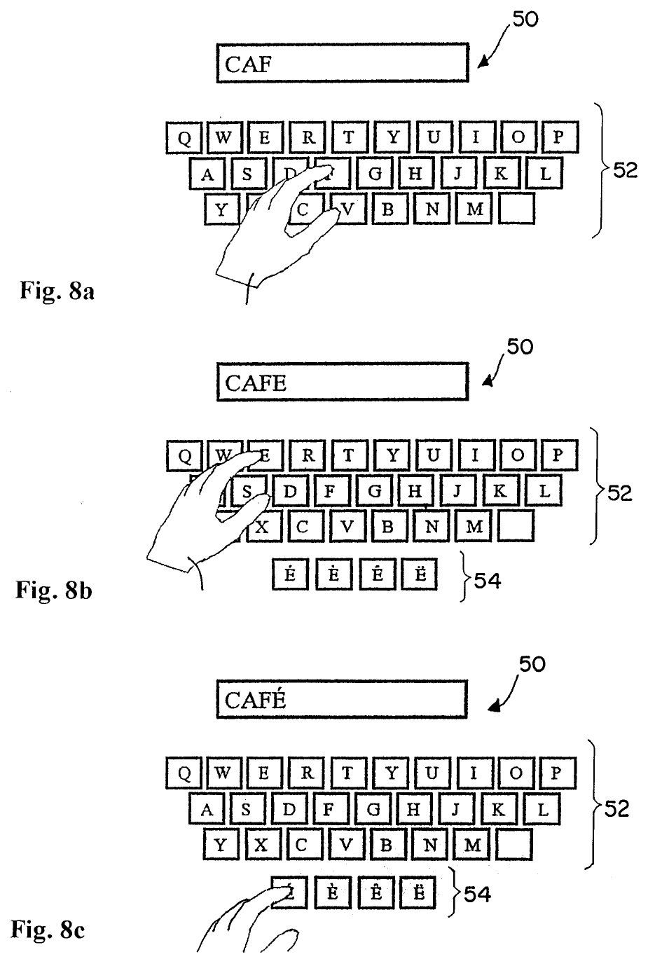

The exemplary variant shown in FIGS. 8a to 8c relates to inputting characters via a screen keyboard. Using a screen generated keyboard, it is possible to activate more key inputs than with conventional keyboards comprising 101 keys. For example, it is possible to support the input of all 191 characters in accordance with ISO 8859-1 by assigning a number of characters to one virtual key. The characters may be assigned using similarity criteria (for example, the character E can be assigned a number of other E characters having different accents). Once the character E has been selected on a keyboard portion 52, various alternative characters are provided in an additional keyboard portion 54 (FIG. 8b). The character E, already written in its basic form, is shown in a control output 50. If, as shown in FIG. 8c, a special character E with an accent is then selected from the row 54, the last inputted character may be replaced with this special character.

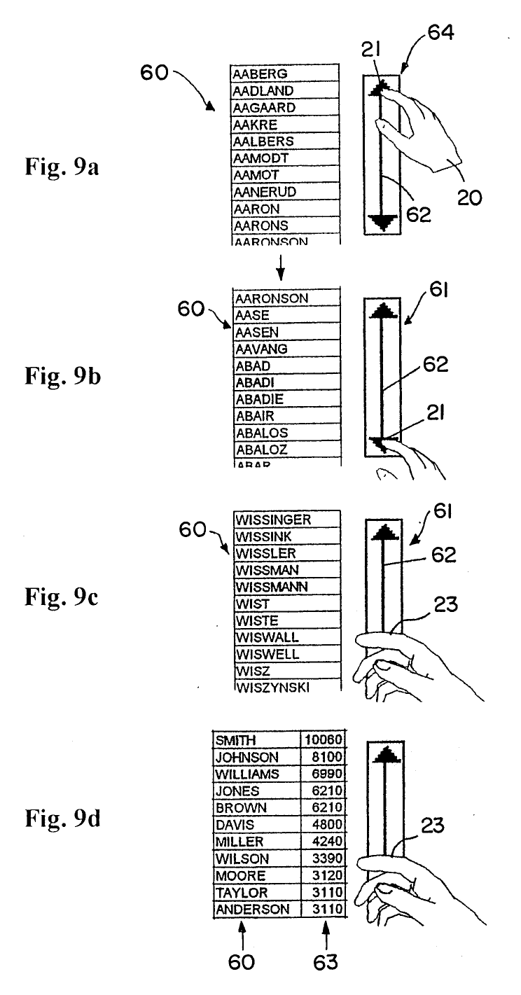

In accordance with another exemplary variation, operating and/or selecting in a scroll bar is illustrated in FIGS. 9a to 9d. In these figures, an alphabetical list of names 60 can be paged through and/or shifted from the top downwards and vice versa using a scroll bar 61. To this end, the scroll bar 61 may include a scroll arrow or scroll region 62. In FIG. 9d, the list 60 has been expanded by a column of FIG. 63. In accordance with the invention, it is possible to scroll through the list 60 by touching the scroll bar 61 in the region of the arrow 62 and guiding the fingertip 21 downwards to page down the list 60 (see, FIGS. 9a and 9b). Drawing or sliding a fingertip 21 while touching the screen affects the process.

Additionally, it is possible to select an element or a particular region by making a planar contact on the scroll bar 61 using a second phalanx 23 of the index finger, as shown in FIG. 9c. When such a planar contact touches a particular position on the arrow 62, the list may jump to a corresponding relative position and the selected region may be displayed. In another example, the displaying order or scrolling order can be changed using a planar selection. In this example shown in FIG. 9d, a planar contact using the second phalanx 23 causes a second list 63 to be opened, that can be scrolled by moving the finger up and down.

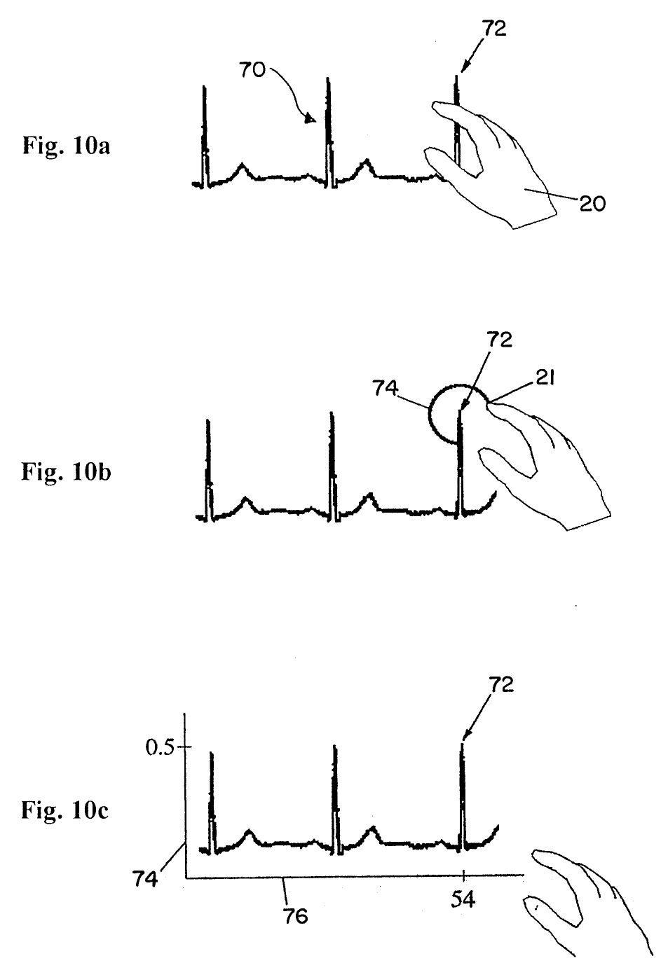

FIGS. 10a to 10c show an exemplary variation in which diagrams are manipulated. A diagram 70 (in this example, an ECG of a patient) includes a peak 72 (FIG. 10a). If a user then wishes to learn more about the value at said peak 72, he can select the point at peak 72 by encircling it with his fingertip 21 (FIG. 10b), whereupon a selection circle 74 appears as confirmation. Upon this selection, the data processing unit can output the values that relate to the peak 72 on axes 74, 76 of the diagram (in this example, 0.5 on axis 74 and 54 on axis 76). Similar evaluations are possible for other measurements or for properties such as color values of the selected point or of a selected area.

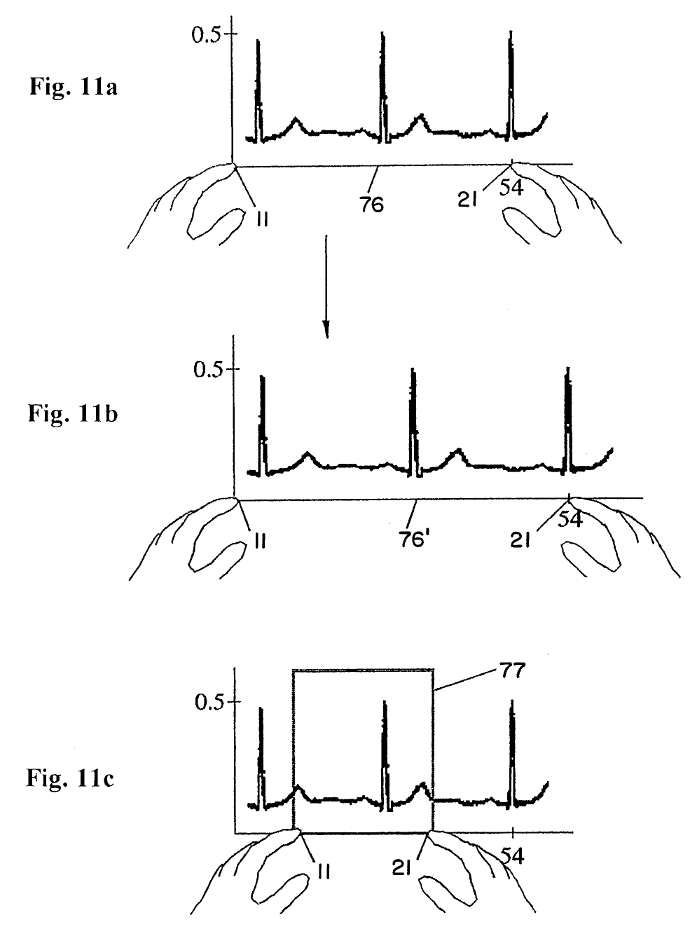

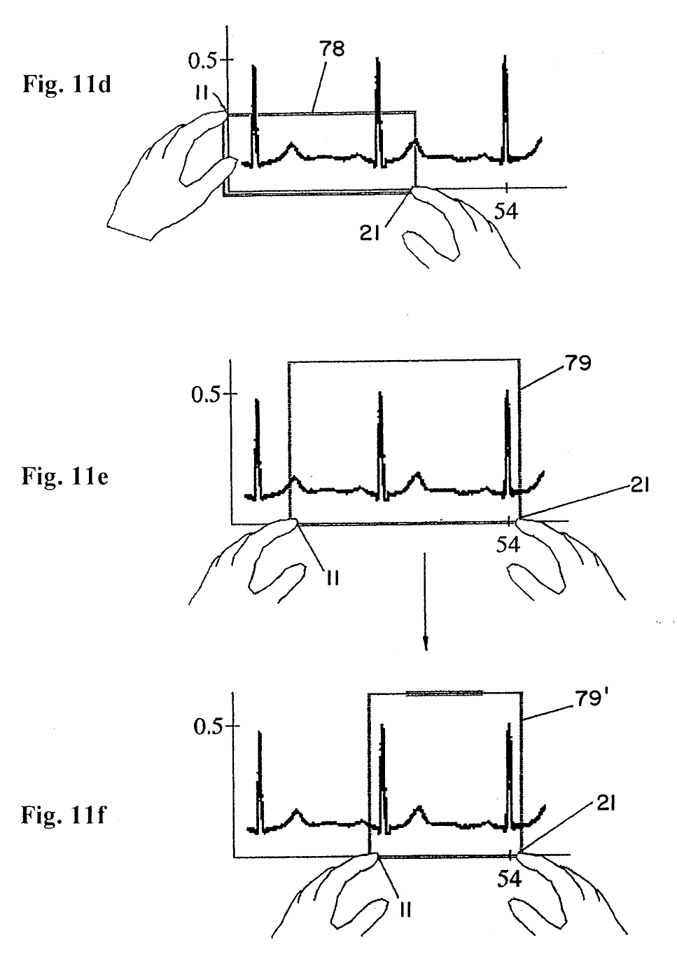

Shown in FIGS. 11a and 11b are exemplary methods of manipulating diagrams. For example, a diagram can be scaled using two fingertip contacts wherein a fingertip 11 touches the origin and remains there and a fingertip 21 shifts a point on an axis 76 to the right, such that a more broadly scaled axis 76′ can be created. FIGS. 11c and 11d show two different ways of selecting a region of a diagram. In FIG. 11c, the region of the diagram may be chosen using two fingertip contacts 11, 21 on the lower axis, and the height of the selected region 77 may be automatically defined such that it includes important parts of the diagram. A selection in which the height itself is chosen for a region 78 is shown in FIG. 11d. The fingertip contacts 11 and 21 define opposing corners of the rectangular region 78. Selections that have already been made can be reset. For example, a selected region 79 (FIG. 11e) can be changed into a region 79′ by shifting the fingertip 11.

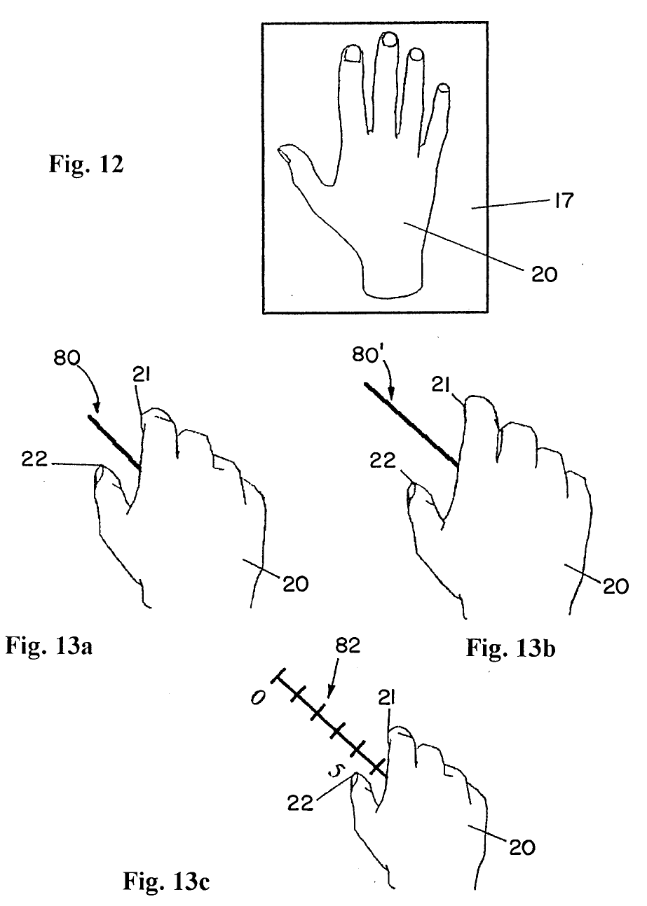

FIG. 12 shows an example in accordance with the invention for communicating to a light box or its data processing unit regardless of whether the user is right-handed or left-handed. Placing a hand 20 flat onto a region 17 of the screen generates a number of contacts, and by detecting the size of different points of contact and the distances between the contacts, it is possible (for example, by comparing with a model of the hand) to ascertain whether it is a right hand or a left hand. The user interface and/or display can be correspondingly set for the respective hand type such that it can be conveniently and optimally handled. In one example, the data processing unit can determine that a right-handed or left-handed determination is to be made when a hand is placed there for a certain period of time.

Using the method in accordance with the invention, as shown in FIGS. 13a to 13c, the user may supplement the image material or image data sets and indicate objects or guidelines. In a dedicated mode, the user can bring two fingertips 21, 22 into contact with the screen, and through this gesture draw a line 80. If the user then moves the fingertips 21, 22 further apart (as shown in FIG. 13b) the line defined at right angles to the connection between the fingertips may be extended (for example, the length of the line may be defined relative to the distance between the fingertips). In another mode, a ruler 82 can be generated in the same manner as shown in FIG. 13c, wherein the scale of the ruler 82 can depend on the distance between the fingertips 21, 22. In this example, it is shown that the interpretation of the input gestures can depend in very general terms on an input mode that may be chosen beforehand or that results from the gestures and/or can be identified from a gesture.

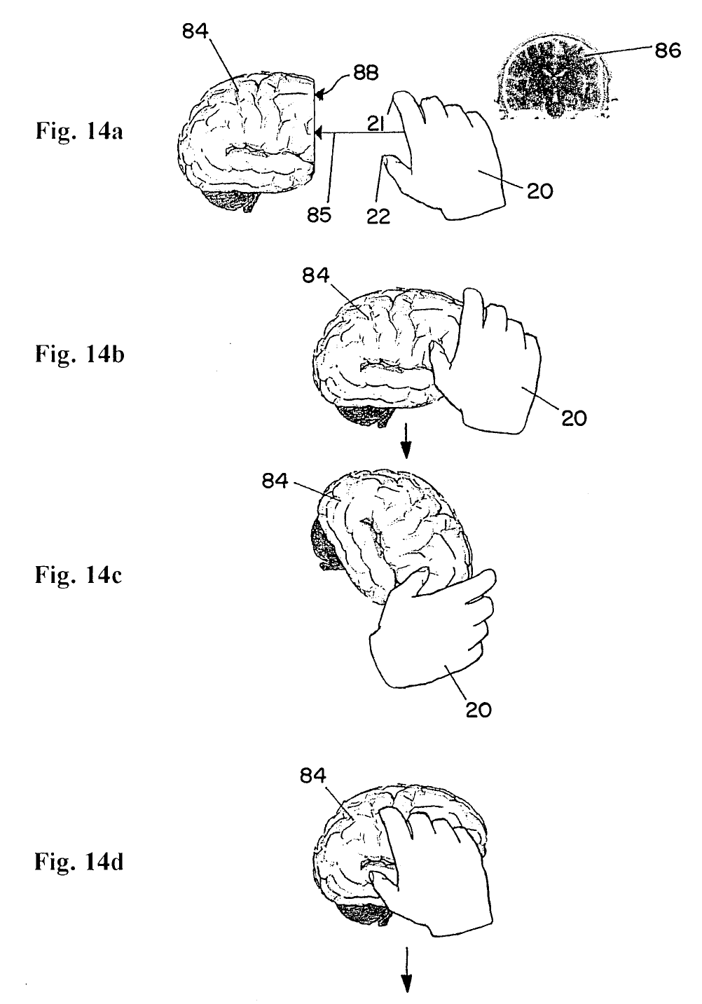

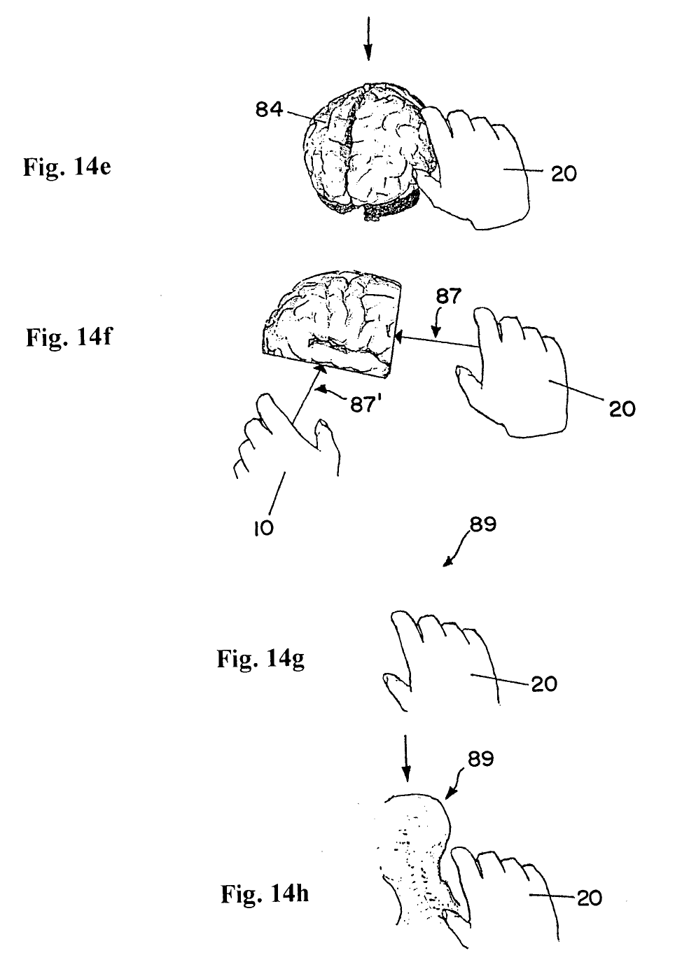

Two-dimensional and three-dimensional image manipulations are shown as examples in FIGS. 14a to 14h. An object displayed on the screen as a three-dimensional model or reconstruction of a patient scan can be manipulated using multiple contacts.

FIG. 14a shows how an incision plane 88 on a brain 84 can be defined and displayed. The incision plane 88 represents a plane to which an arrow 85 is pointing. The arrow 85 may be generated by two fingertip contacts 21, 22, and its length may depend on the distance between the fingertips 21, 22. The arrow 85 is directed perpendicularly onto the plane 88. If the fingertips 21, 22 then are moved further apart or nearer to each other, the location of the incision plane 88 may be changed and a corresponding sectional image 86 may be shown adjacent to it.

Thus, by moving the fingertips 21, 22, the representation 86 can be “scrolled” through various incision planes as an orthogonal incision plane.

FIGS. 14b and 14c show how, by shifting two contacts in a rotational movement, it is possible to rotate a three-dimensional object about an axis that is parallel to the viewing direction and centred on the line between the two contacts.

If two contacts are shifted or drawn in the same direction, as shown in FIGS. 14d and 14e, the three-dimensional object 84 may be rotated about an axis that is perpendicular to the viewing direction (for example, parallel to a line between the two points and centered on the center of the three-dimensional object 84. FIG. 14f shows how two two-finger lines 87, 87′ can be used to generate incision planes in a similar way to FIG. 14a, wherein a three-dimensional object wedge can be defined.

FIGS. 14g and 14h show that the described rotational processes can be applied to two-dimensional representations that originate from a three-dimensional data set or have been otherwise assigned to each other. By moving a two-finger contact in parallel towards one side, a representation 89 may be rotated by 90 degrees from the state in FIG. 14g to the state in FIG. 14h. In this manner, it is possible to switch between sagittal, axial, and coronary orientations of the data set. In the case of a sagittal image, the orientation could be altered to an axial orientation by positioning the finger contacts on the upper part of the image and drawing the contact downwards.

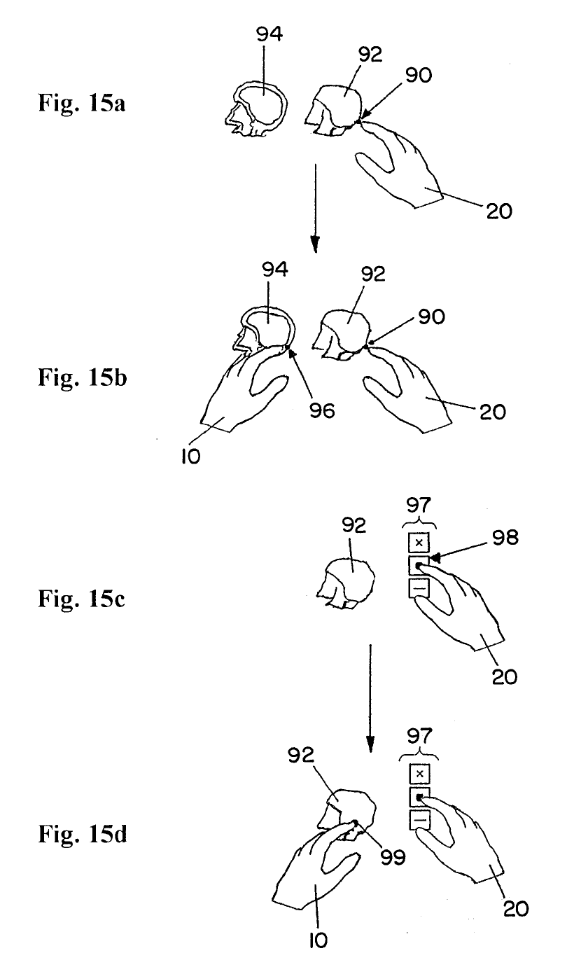

Another aspect of the invention relates to so-called “pairing” or the assigning of two or more object points. During patient to data set or data set to data set registration or when fusing or matching two different images, individual points from the two images can be identified and assigned as the same object point in the two images. FIGS. 15a and 15b show how a first point 90 on an image 92 and then a corresponding point 96 on another image 94 can be marked using a fingertip. FIGS. 15c and 15d show another embodiment in which a GUI (Graphic-User Interface) element 98 may be first chosen (to select a label 99) from a selection 97 using a fingertip contact, whereupon a fingertip contact using the other hand 10 then can attach the label 99 at the desired position.

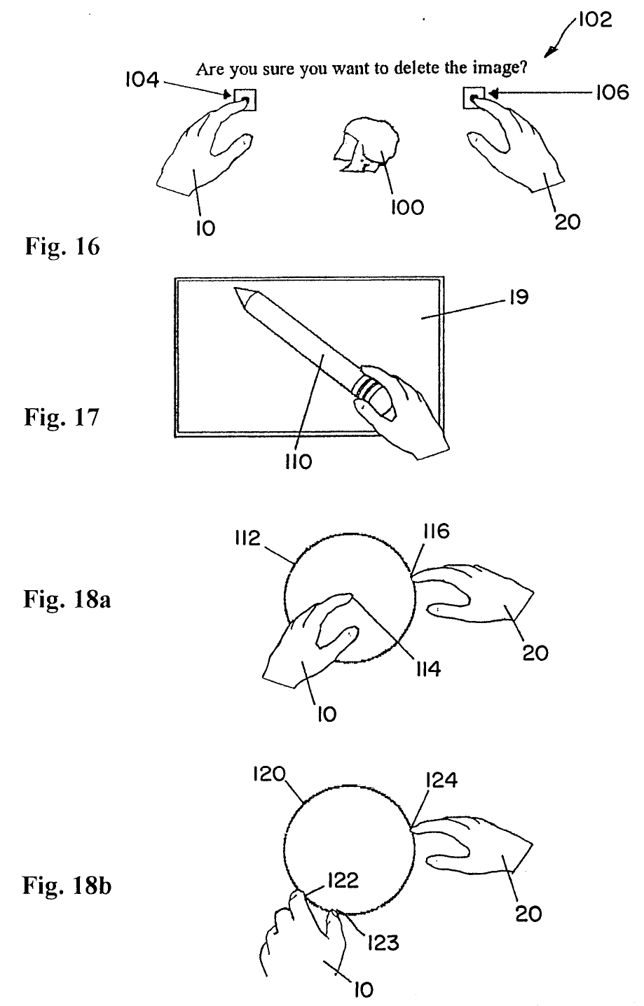

Because information can be lost if some images are inadvertently deleted, an application configured in accordance with the invention also can provide protection against deletion. For example, FIG. 16 shows how a delete confirmation for the image 100 may be requested and triggered by a two-handed contact with buttons 104 and 106 following a request 102. FIG. 17 shows an application in which the dimensions of an actual object can be determined/measured (for example, a pointing device 110 that is moved to a screen portion 19). If a corresponding mode has been set, or the object 110 remains on the screen for an extended period of time, the system may be triggered to gage the area of contact (and/or counting the number of contacts) and corresponding object dimensions can be detected.

FIGS. 18a and 18b show how using corresponding gestures, a geometric object (in this example, a circle) can be generated on the screen. In FIG. 18a, a circle 112 may be generated by pointing one fingertip at a center point 114 and another fingertip at a circumferential point 116, while in FIG. 18b, a circle 120 is inputted using three circumferential points 122, 123, and 124.

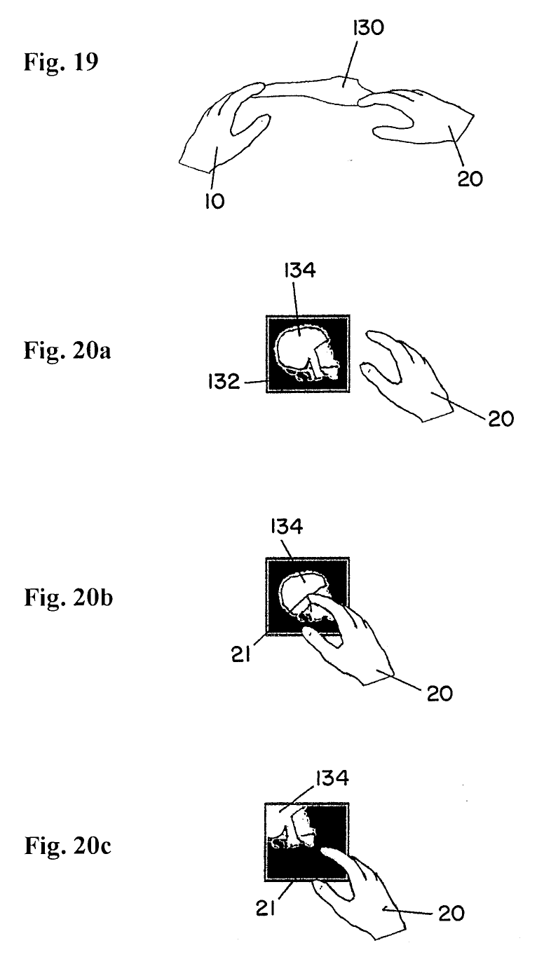

Representations of medical implants also can be manipulated on the screen as shown schematically in FIG. 19. An implant 130 can be altered using enlarging gestures, reducing gestures, or rotating gestures such as described herein. If other image data sets are available on the screen (for example, anatomical structures into which the implant can be introduced) a suitable implant size can be planned in advance on the screen. It is also possible to have the computer compare the adapted implant with various stored, available implant sizes. If a suitable implant is available and correspondingly outputted by the database, it is possible to choose or appoint this implant. Alternatively, necessary adaptations to the nearest implant in size may be calculated and outputted.

In accordance with another aspect of the invention, the examples in FIGS. 20a to 20c show how a gesture can be interpreted differently depending on the part of the image to which the gesture is applied. The image shown in the figures includes a bright region of a head 134 and a dark region 132 surrounding the head. If a fingertip 21 points to the bright region 134 and then if the finger is drawn over the bright region (FIG. 20b), this gesture can be interpreted as a command for scrolling through different incision planes. If, however, the fingertip 21 rather is placed on the dark region, this gesture can be interpreted as a command for shifting the image, as shown in FIG. 20c.

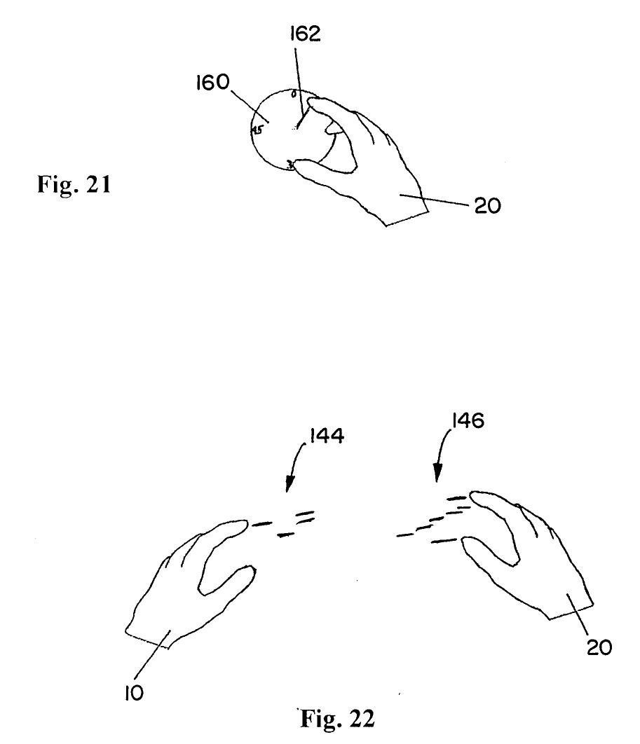

In operating theaters, it is sometimes necessary to observe certain periods of time such as when a material has to harden. To be able to measure these periods, gesture recognition can be used to show and set a clock and/or a countdown. FIG. 21 shows an example in accordance with the invention wherein a contact using two fingers may cause a countdown clock 140 to appear on the screen. If the index finger then may be rotated around the thumb, the gesture may cause a clock hand 142 to be shifted, and the countdown can begin from this preset time.

FIG. 22 illustrates the input of a signature via multiple contact 144, 146 with the screen. If a sequence of lines is inputted simultaneously or consecutively using a specified and identified sequence of gestures, the system can identify and record the presence of a particular user.

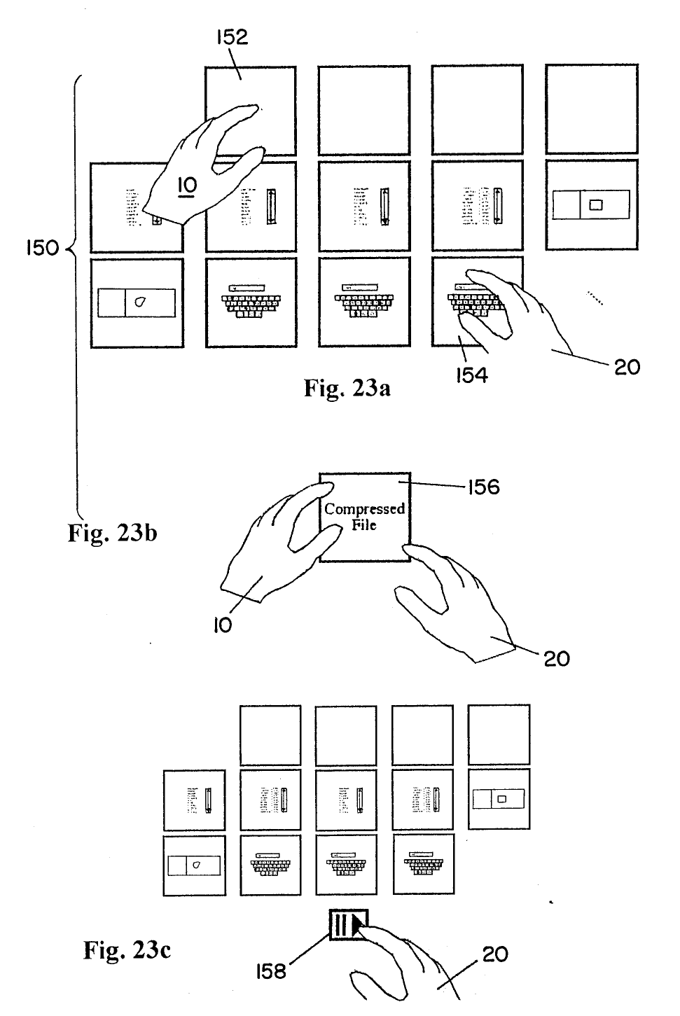

FIGS. 23a to 23c relate to multiple selection of image elements or image objects or to handling such elements or objects. FIG. 23a shows a number of image objects 150 wherein a first image 152 and a final image 154 of a sequence of images to be selected can be selected using two contacts in a corresponding selection mode. The first contact using a hand 10 on the image 152 can remain active until the image 154 also has been selected. The multiple selection of images then can be entered into different processes or used in different ways. One such use is shown in FIG. 23b wherein all of the images selected can be processed into a compressed file 156. The process may be initiated by a reducing or zoom-in gesture made using both hands, wherein the two fingertips may be guided towards each other while they are touching the screen. Another exemplary application, shown in FIG. 23c, may be that of playing a film or sequence of images from selected files, wherein this process can be initiated using a corresponding gesture or by activating a play button.

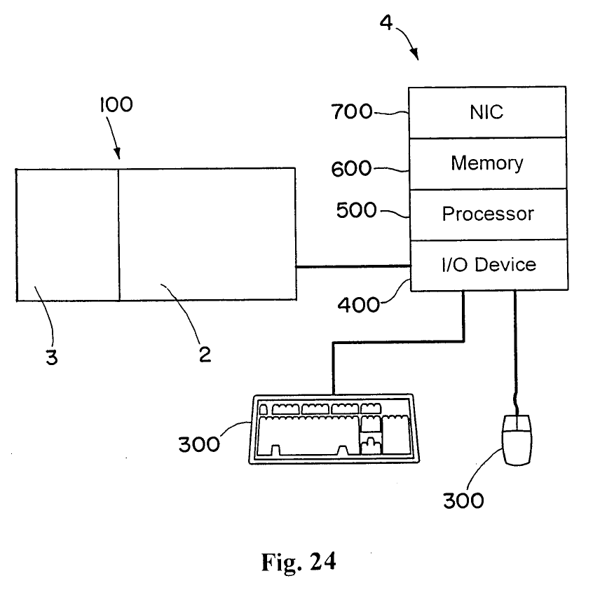

Turning now to FIG. 24 there is shown a block diagram of an exemplary data processing unit or computer 4 that may be used to implement one or more of the methods described herein. As described herein, the computer 4 may be a standalone computer, or it may be integrated into a digital light box 1, for example.

The computer 4 may be connected to a screen or monitor 200 having separate parts 2, 3 for viewing system information and image data sets. The screen 200 may be an input device such a touch screen for data entry, screen navigation and gesture instruction as described herein. The computer 4 may also be connected to a convention input device 300 such as a keyboard, computer mouse or other device that points to or otherwise identifies a location, action, etc., e.g., by a point and click method or some other method. The monitor 200 and input device 300 communicate with a processor via an input/output device 400, such as a video card and/or serial port (e.g., a USB port or the like).

A processor 500 combined with a memory 600 execute programs to perform various functions, such as data entry, numerical calculations, screen display, system setup, etc. The memory 600 may comprise several devices, including volatile and non-volatile memory components. Accordingly, the memory 600 may include, for example, random access memory (RAM), read-only memory (ROM), hard disks, floppy disks, optical disks (e.g., CDs and DVDs), tapes, flash devices and/or other memory components, plus associated drives, players and/or readers for the memory devices. The processor 500 and the memory 600 are coupled using a local interface (not shown). The local interface may be, for example, a data bus with accompanying control bus, a network, or other subsystem.

The memory may form part of a storage medium for storing information, such as application data, screen information, programs, etc., part of which may be in the form of a database. The storage medium may be a hard drive, for example, or any other storage means that can retain data, including other magnetic and/or optical storage devices. A network interface card (NIC) 700 allows the computer 4 to communicate with other devices. Such other devices may include a digital light box 1.

A person having ordinary skill in the art of computer programming and applications of programming for computer systems would be able in view of the description provided herein to program a computer system 4 to operate and to carry out the functions described herein. Accordingly, details as to the specific programming code have been omitted for the sake of brevity. Also, while software in the memory 600 or in some other memory of the computer and/or server may be used to allow the system to carry out the functions and features described herein in accordance with the preferred embodiment of the invention, such functions and features also could be carried out via dedicated hardware, firmware, software, or combinations thereof, without departing from the scope of the invention.

Computer program elements of the invention may be embodied in hardware and/or in software (including firmware, resident software, micro-code, etc.). The invention may take the form of a computer program product, that can be embodied by a computer-usable or computer-readable storage medium having computer-usable or computer-readable program instructions, “code” or a “computer program” embodied in the medium for use by or in connection with the instruction execution system. In the context of this document, a computer-usable or computer-readable medium may be any medium that can contain, store, communicate, propagate, or transport the program for use by or in connection with the instruction execution system, apparatus, or device. The computer-usable or computer-readable medium may be, for example but not limited to, an electronic, magnetic, optical, electromagnetic, infrared, or semiconductor system, apparatus, device, or propagation medium such as the Internet. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner. The computer program product and any software and hardware described herein form the various means for carrying out the functions of the invention in the example embodiments.

Although the invention has been shown and described with respect to a certain preferred embodiment or embodiments, it is obvious that equivalent alterations and modifications will occur to others skilled in the art upon the reading and understanding of this specification and the annexed figures. For example, regard to the various functions performed by the above described elements (components, assemblies, devices, software, computer programs, etc.), the terms (including a reference to a “means”) used to describe such elements are intended to correspond, unless otherwise indicated, to any element that performs the specified function of the described element (i.e., that is functionally equivalent), even though not structurally equivalent to the disclosed structure that performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A method for processing and/or displaying medical image data sets in or on a display device having a screen with a surface, comprising:
detecting gestures performed on or in front of the screen surface;
correlating the gestures to predetermined instructional inputs; and
manipulating, generating, or retrieving, via computer support, the medical image data sets in response to the instructional inputs.

2. The method according to claim 1, further comprising a data processing unit integrated with the display device.

3. The method according to claim 1, wherein the instruction inputs comprise control inputs for displaying medical image data sets and/or medical data on the screen.

4. The method according to claim 1, wherein the screen is touch sensitive and the gestures are performed by making contact with the surface of the screen.

5. The method according to claim 1, wherein the screen is configured to detect presences near the surface of the screen and the gestures are performed without making contact with the surface of the screen.

6. The method according to claim 1, wherein the display device can identify a number of simultaneous contacts with the surface of the screen or a number of simultaneous presences near the surface of the screen.

7. The method according to claim 1, wherein correlating the gestures to predetermined instructional inputs comprises:
identifying a defined sequence of gestures and correlating the defined sequence of gestures to at least one instructional input,
identifying simultaneous gestures at a number of positions on the screen and correlating the simultaneous gestures to at least one instructional input, and/or
identifying individual gestures over a certain period of time and correlating the simultaneous gestures to at least one instructional input.

8. The method according to claim 1, wherein said gestures comprise differentiated punctual or planar contacts with the surface of the screen or presences near the surface of the screen.

9. The method according to claim 1, wherein the display device comprises at least two screens arranged next to each other and wherein one screen serves for retrieving and/or selecting image data sets or medical data and the other screen serves for manipulating or generating image data sets or medical data.

10. The method according to claim 1, further comprising: interpreting gestures causing planar contact with the surface of the screen as different input commands to gestures causing punctual contact with the surface of the screen.

11. The method according to claim 10, wherein when the gestures causing contact with the screen are directed to a single input field on the screen.

12. The method according to claim 1, further comprising correlating gestures to instructional inputs defined to control image properties.

13. The method according to claim 12, wherein the image properties comprise zoom factor, brightness, contrast, and/or selection of screen fields.

14. The method according to claim 1, further comprising correlating the gesture(s) to an instructional input defined to enlarge an image region or a region of the screen.

15. The method according to claim 1, further comprising correlating the gesture(s) to an instructional input defined to generate a polygon.

16. The method according to claim 15, wherein the gesture(s) comprise simultaneous or consecutive punctual inputs and/or multiple planar contacts with the surface of the screen and wherein the polygon comprises delineating and/or defining image regions.

17. The method according to claim 1, further comprising correlating linear gesture(s) or a number of simultaneous linear input gestures to an instructional input defined to mirror an image.

18. The method according to claim 1, further comprising correlating gesture(s) to an instructional input defined to retrieve a hidden input field and/or select an input command within the field.

19. The method according to claim 1, further comprising correlating gesture(s) to an instructional input defined to retrieve and/or operate a displayed screen keyboard.

20. The method according to claim 1, further comprising correlating gesture(s) to an instructional input defined to activate scroll bars at different scrolling speeds or to use different selection list criteria.

21. The method according to claim 1, further comprising correlating gesture(s) to an instructional input defined to select a point or region in a linear or planar diagram, wherein:
the co-ordinates of the point or region are outputted on axes of the diagram or at an assigned area of the image;
the scale of the diagram is changed by a sequence of further gestures; and/or
regions of the diagram are enlarged, reduced or shifted.

22. The method according to claim 1, further comprising correlating multiple or planar contacts with the surface of the screen or presences at the surface of the screen to an instructional input defined to set the correlation of subsequent gestures in a right-handed or left-handed framework.

23. The method according to claim 1, further comprising correlating two punctual inputs to an instructional input defined to insert a dimensioned line into the image or image data set, wherein the distance between the punctual inputs defines and/or alters the length of the line.

24. The method according to claim 1, further comprising correlating gestures comprising multiple or planar contacts with the surface of the screen, or presences near the surface of the screen, or simultaneous or consecutive punctual inputs to an instructional input defined to manipulate two-dimensional or three-dimensional representations of an image data set that has been produced using a medical imaging method.

25. The method according to claim 24, wherein the manipulation comprises:
rotating, tilting, or mirroring the representations;
defining or altering an incision plane in a displayed image, and/or correspondingly displaying a sectional representation of the image data set; and/or
shifting the representation.

26. The method according to claim 1, further comprising correlating simultaneous or consecutive punctual inputs to an instructional input defined to assign image points in pairs or multiples.

27. The method according to claim 26, wherein the image points in pairs or multiples comprise the same image points in different views of an image data set.

28. The method according to claim 1, further comprising correlating gesture(s) to a instructional input(s) defined to confirm commands.

29. The method according to claim 1, further comprising identifying and/or gaging an object that is placed in contact with the screen after the object is left in contact with the screen for a defined period of time.

30. The method according to claim 1, further comprising correlating gesture(s) to an instructional input defined to generate geometric figures or bodies as contours.

31. The method according to claim 1, further comprising correlating gesture(s) to an instructional input defined to scale or adapt the size of objects.

32. The method according to claim 31, wherein the objects comprise implants.

33. The method according to claim 1, further comprising correlating gesture(s) to an instructional input defined to affect an image content of an image region

34. The method according to claim 33, wherein the image content comprises the image brightness.

35. The method according to claim 33, wherein different gestures are correlated to different instructional inputs defined to execute a different control function that is different for different image contents.

36. The method according to claim 1, further comprising correlating simultaneous or consecutive punctual inputs to instructional inputs defined to activate and/or set and/or trigger a clock or countdown counter on the screen.

37. The method according to claim 1, further comprising further comprising correlating gesture(s) to an instructional input defined to input a signature.

38. The method according to claim 1, further comprising correlating gesture(s) to an instructional input defined to make a multiple selection of image elements by selecting a first and a final image element.

39. The method according to claim 38, wherein the image elements comprise files and a gesture is correlated to an instructional input defined to produce a compressed file from the files.

40. The method according to claim 38, wherein the image elements comprise images and a gesture is correlated to an instructional input defined to start an image sequence consisting of the selected image elements.

41. A computer program embodied on a computer readable medium for processing and/or displaying medical image data sets in or on a display device having a screen with a surface, comprising:
code for detecting gestures performed on or in front of the screen surface;
code for correlating the gestures to predetermined instructional inputs; and
code for manipulating, generating, or retrieving, via computer support, the medical image data sets in response to the instructional inputs.
